(19) United States
(12) Patent Application Publication
(10) Pub. No.: US 2011/0030867 A1
(43) Pub. Date: Feb. 10, 2011

(54) PNEUMATIC TIRE SECURITY SYSTEM

(76) Inventor: Ronald Kyle, Akron, OH (US)

Correspondence Address: Allen M. Krass;Gifford, Krass, Sprinkle, Anderson & Citkowski, PC, 2701 Troy Center Drive, Suite 330, Post Office Box 7021, Troy, MI, 48007-7021, US

(21) Appl. No.: 12/848,259

(22) Filed: Aug. 2, 2010

Related U.S. Application Data
(60) Provisional application No. 61/231,838, filed on Aug. 6, 2009.
(60) Provisional application No. 61/287,245, filed on Dec. 17, 2009.

(51) Int. Cl. B60C 17/02

(52) U.S. Cl. 152/519; 152/516

(57) ABSTRACT

A system for allowing vehicles equipped with pneumatic tires to continue operating after a tire failure which would normally cause deflation of the tire employs one or more airbags stored in deflated configuration either about the exterior surface of the rim supporting the pneumatic tire or externally of the tire. The system further includes a container for compressed gases. A sensor connected to the inflated tire to detect sudden deflation releases the compressed gases so as to inflate the airbag to either support the tire or provide an exterior running surface adjacent to the deflated tire.

### CROSS-REFERENCE TO RELATED APPLICATIONS

This Application claims the benefit of U.S. Provisional Application 61/287,245 filed on Dec. 17, 2009, and U.S. Provisional Application 61/231,838, filed on Aug. 6, 2009.

### FIELD OF THE INVENTION

This invention relates to pneumatic tires and more particularly to a system employing auxiliary airbags associated with the tires and a source of pressured gasses which may be released to expand the airbags in the event of an accidental deflation of the tires.

### BACKGROUND OF THE INVENTION

A failure of a pneumatic tire can expose the occupants of the affected vehicle to excessive risks of having to stop in high speed traffic or other high risk environments to evaluate the damage, to change the wheel and tire assembly, or to move slowly in an aggressive flow of traffic to a place of relative safety.

The problem of pneumatic tire failure is particularly aggravated in military vehicles which may be operating in dangerous areas and in commercial and off-the-road vehicles where the cost of lost time required to recover from tire damage may be very significant.

### SUMMARY OF THE INVENTION

Accordingly, the present invention is directed toward a security system for pneumatic tires of vehicles which will allow the vehicles to continue operation, for at least limited periods of time, after damage to one of the vehicle's pneumatic tires which would normally disable the vehicle.

The systems of the present invention involve collapsible, substantially gas impervious bags which may be stored in collapsed form either within the interior volume of a tire to be protected, or externally thereto, and which may be inflated upon the detection of a pressure change in the associated pneumatic tire which would impair it's continued use. These systems employ a tank for storing compressed gas which can be used to inflate the collapsed bags in the event of the detection the failure of the pneumatic tire. Compressed gas sources may be associated with each tire of the vehicle, or alternatively, a single compressed gas tank may service several tires or all the tires of the vehicle.

In the form of the invention in which the collapsed bags are stored within each tire volume, they are preferably retained within the wheel rim so as to not hinder the normal operation of the tire, but when a traumatic decrease in pressure in the associated tire is detected, they can then be inflated to occupy sufficient volume within the disabled tire to allow the vehicle to continue normal operation, at least for a limited period of time. Depending on such factors as the tire size and the nature of the vehicle, one or more bags may be associated with each tire. When more than one bag is utilized they are preferably arranged at equal angles about the perimeter of the rim so that when expanded the volume within the tire is equally filled with the bags.

In an alternative embodiment in which the airbags are stored externally of each tire they are similarly arrayed at equal circumferential intervals so that when expanded they effectively create an auxiliary tire which is supported adjacent to it on the same axle as the damaged tire to allow continued use of the vehicle.

In still another embodiment of the invention, the tires may be protected by one or more airbags supported within the rim volume as well as a number of external airbags. Airbags stored within the tire volume could re-inflate the tire which would then share the vehicle load with the exterior airbags which are simultaneously inflated.

### BRIEF DESCRIPTION OF THE DRAWINGS

Other objectives, advantages, and applications of the present invention will be made apparent by the following detailed description of the preferred embodiment of the invention. The description makes reference to the accompanying drawings in which:

FIG. 1 is a cross section through a conventional pneumatic tire supported on a two piece wheel rim which also contains collapsed gas bags and a compressed gas inflation source for the collapsed bags;

FIG. 2 is a plan view of the device of FIG. 1;

FIG. 3 is a sectional view through an alternative embodiment of the present invention supported on a one piece wheel rim;

FIG. 4 is a plan view of the device of FIG. 1;

FIG. 5 is a cross sectional view of an embodiment of the invention like that in FIG. 3 with the gas bags inflated and a portion of the tire blown away;

FIG. 6 is a schematic illustration of an embodiment of the invention with 16 gas bags disposed at equal circumferential intervals about the interior volume of a tire;

FIG. 7 is a sectional view through an embodiment of the invention employing a gas bag externally of the tire volume;

FIG. 8 is a view of the device of FIG. 7 with the external airbags inflated so as to create an auxiliary tire to support the vehicle in the event of failure of the basic pneumatic tire;

FIG. 9 is a front view of a cover adapted to surround an emergency system like that shown in FIGS. 1 and 3, adapted to be disposed on the radial interior side of the gas bags which are collapsed within the rim; and

FIG. 10 is a side view of the cover of FIG. 9.

### DETAILED DESCRIPTION OF THE PREFERRED EMBODIMENTS

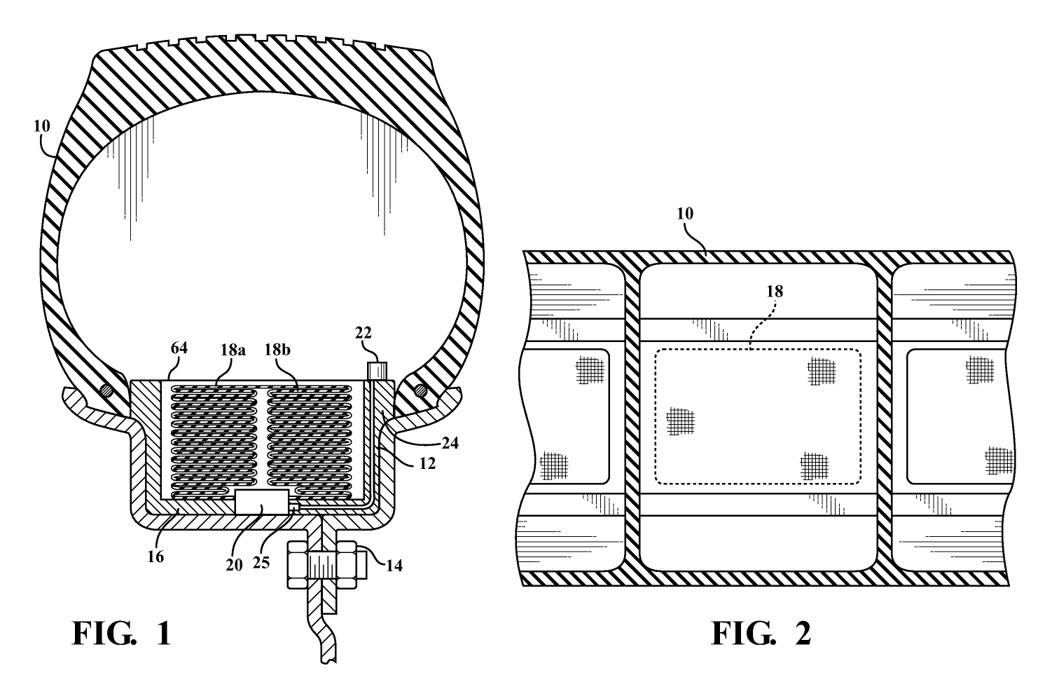

Referring to FIGS. 1 and 2, a first embodiment of the invention in which the collapsible air (or “gas”) bags are stored within the volume of the pneumatic tire 10 being protected, is illustrated. The tire 10 is shown in its inflated, undamaged position. The tire is affixed to a two piece wheel rim system 12 with the two sections of the rim being secured to one another by a nut and bolt 14. A bead support and air assembly ring 16, which may extend fully around the perimeter of the wheel is supported on the interior side of the rim. The ring 16 is generally u-shaped in cross-section and supports two collapsed airbag sections 18a and 18b within the “U”. A source of the compressed air or other gas, such as nitrogen, 20 is retained against the interior surface of the rim.

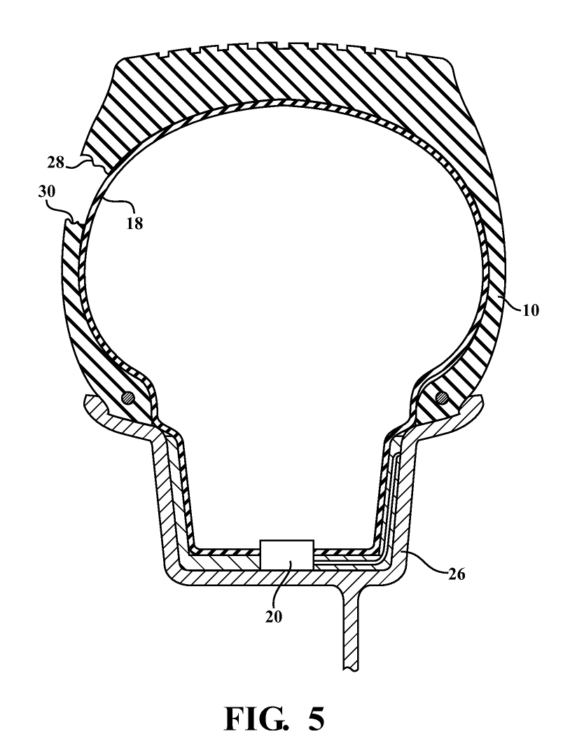

A tire pressure sensor 22 is supported on the airbag assembly ring 16 within the inflated volume of the tire 10. The sensor 22 may be of any conventional pressure sensitive type such as the diagram supported by a spring and preferably includes a small battery (not shown). When the sensor 22 detects a sudden decrease in the tire pressure below the usual value, an electrical signal is sent on line 24 to an output valve 25 connected to the air bag inflation device 20 which then releases it's pressurized gas into the bags 18a and 18b causing them to inflate in the manner generally indicated in FIG. 5.

FIG. 2 is a view looking downwardly from within the tire volume to the bags 18a and 18b. It illustrates that the device in FIG. 1 is associated with a particular segment of the wheel rim 12. A plurality of similar segments may be arrayed at spaced intervals on an entire perimeter of the rim or a relatively few bags could be placed at equal intervals along the rim.

In an alternative embodiment of the invention a single tire pressure sensor 22 might service a number airbags spaced along the rim. Additionally, a single container of compressed gas 20 might be supported on the vehicle with output connections to a plurality of airbags spaced about the rim.

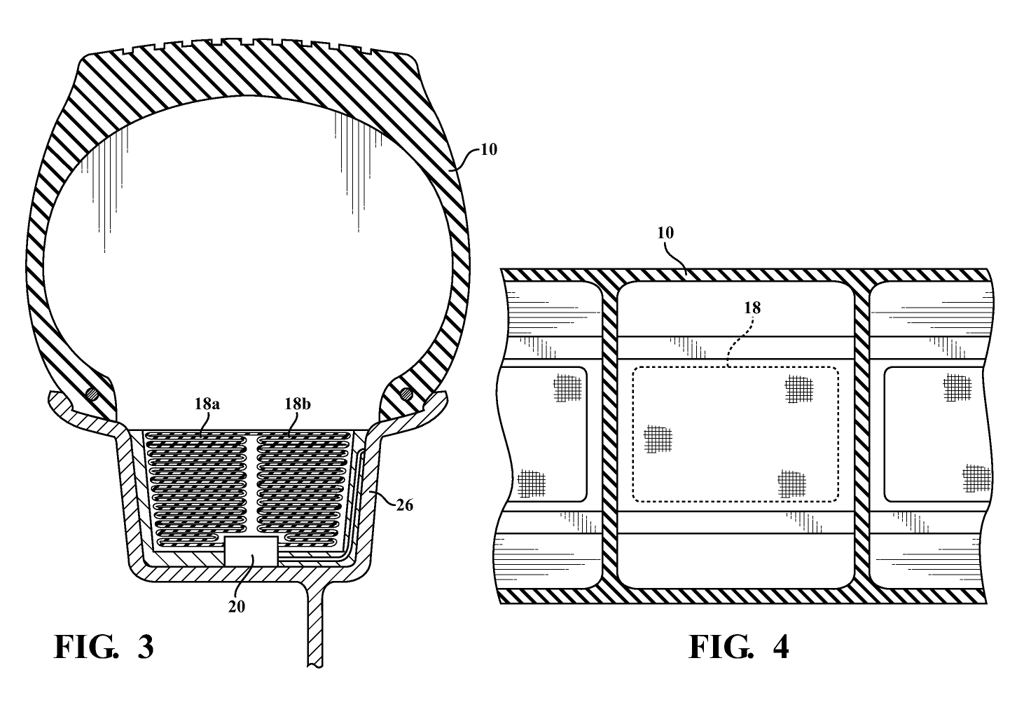

FIGS. 3 and 4 are very similar to FIGS. 1 and 2 and illustrate a one piece rim 26.

When the air bags 18a and 18b are inflated, they combine to fill the normal volume occupied by an inflated tire, as illustrated in FIG. 5. In FIG. 5 a section of the tire 10 is illustrated as broken away between the ends 28 and 30, but the vehicle may be continued to be driven at least for a relatively short period of time, on the inflated air bag 18.

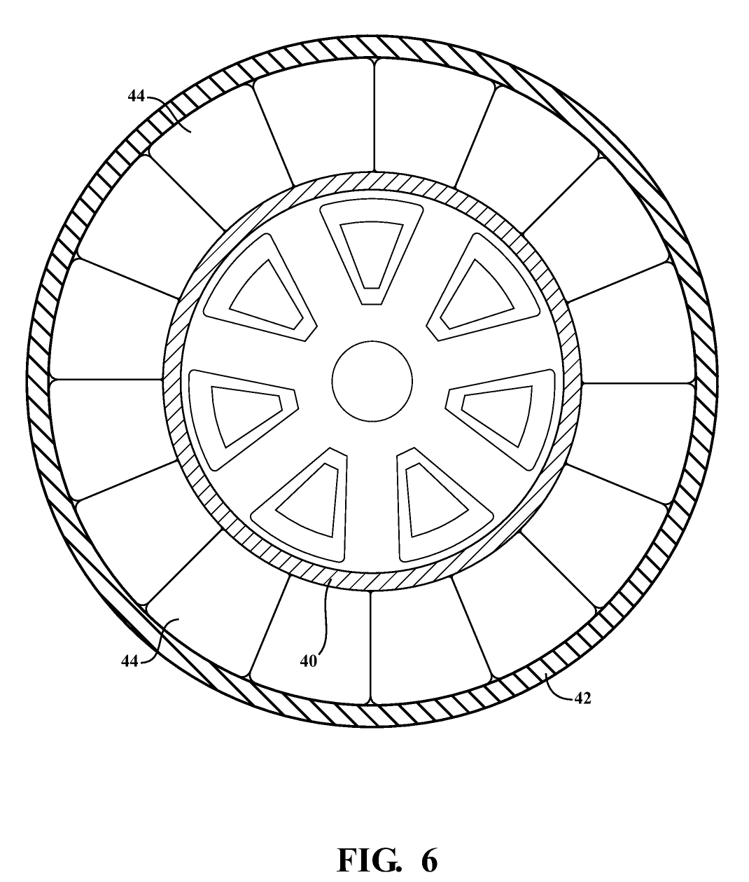

FIG. 6 is a schematic diagram of a tire equipped with an airbag system formed in accordance with the present invention taken through a plan transverse to the wheel axis. The volume between the wheel rim 40 and the original tire tread 42 is populated by 16 airbag segments 44, arranged at equal circumferential intervals about the tire rim 40. As has been noted the segments 44 may not be immediately adjacent to one another but could be spaced about the wheel. The number of airbags utilized will be depend upon the size of the tire, the nature of the vehicle, the area in which it is being used, and similar factors.

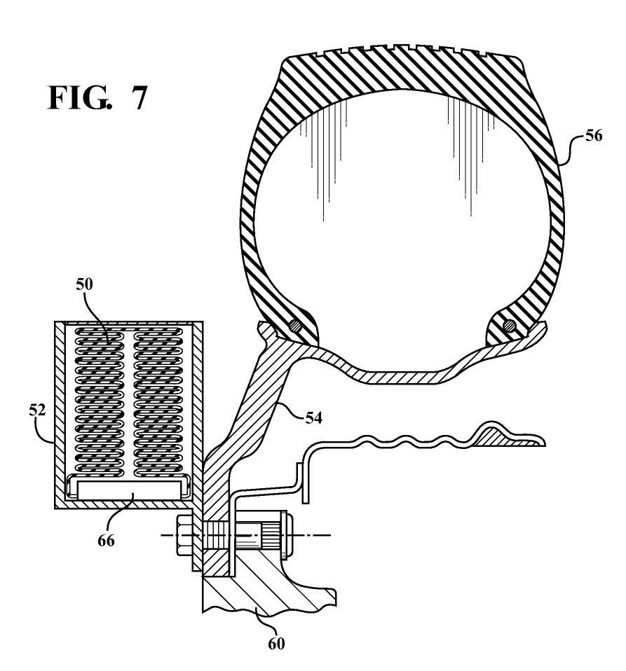

An alternative embodiment to the invention is illustrated in FIG. 7 wherein one or more airbags 50 are supported in container 52 affixed to a wheel rim 54, but outside of the volume of the pneumatic tire 56. In FIG. 7 the container 52 is secured to the wheel rim 54 by the same bolt 58 which secures the rim to the wheel hub 60.

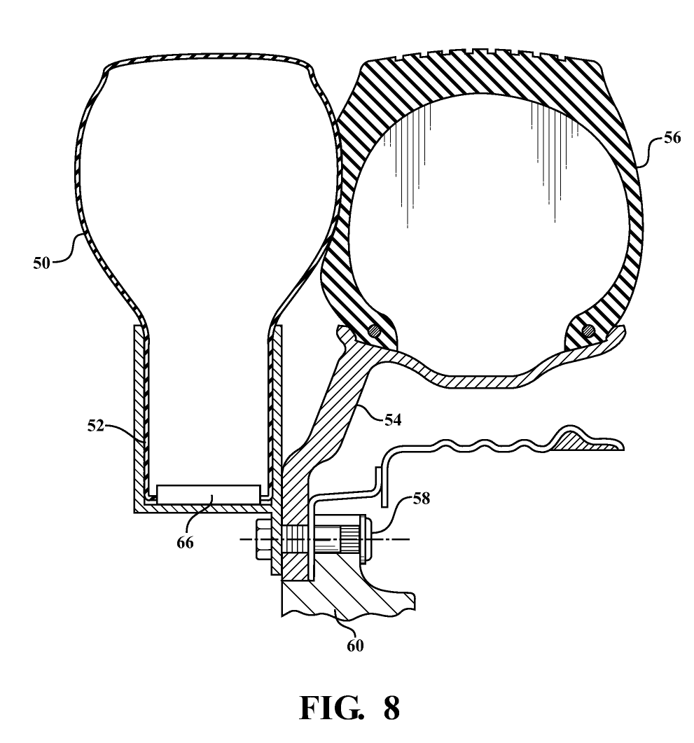

FIG. 8 illustrates the airbag 50 in inflated form which occurs when the tire 56 is damaged so the air pressure on it's interior suddenly decreases which is sensed by a sensor (not shown) and sends the signal to the compressed gas container 62 valve to release it's compressed gas into the airbag 50. The bag then assumes a shape similar to the undamaged pneumatic tire to provide an emergency tire that may be used for limited period of time.

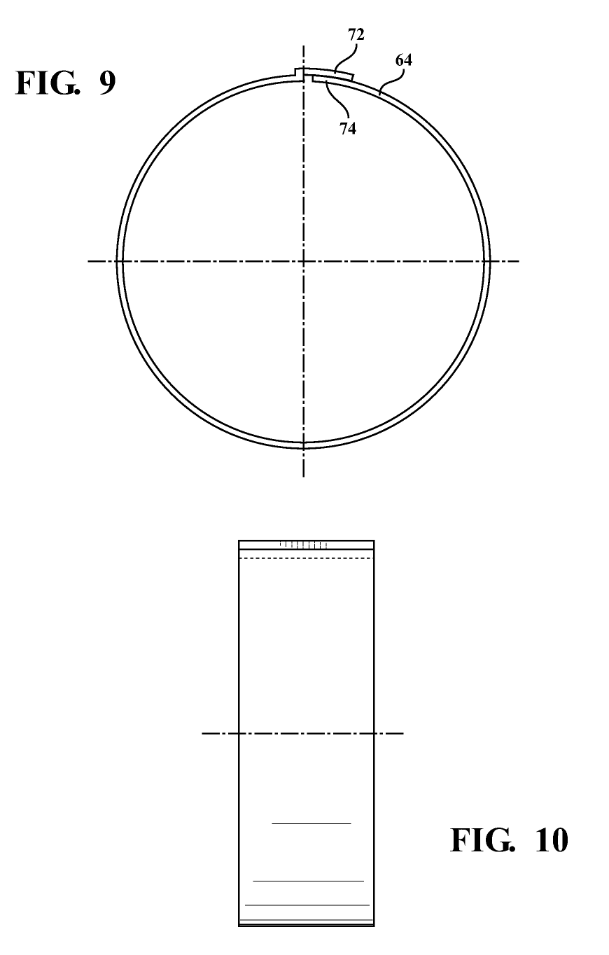

The compacted airbags such as 18 may be protected by an airbag cover 64 illustrated in FIG. 9 and FIG. 1, which extends over the radial interior surfaces of all the airbags associated with the wheel. FIG. 10 and FIG. 1 shows the wheel cover in plan view transverse to the wheel axis and FIG. 9b shows the side view of the cover extending parallel to the wheel axis. The cover 64, normally lies in a closed hoop configuration with it's two ends 72 and 74 overlapping one another. When the associated airbags are inflated the ends 72 and 74 slip away from one another, allowing the hoop to open so that the airbags my escape into the interior of the tire volume.

Having thus described my invention I claim;

1. A security system for a pneumatic tire supported on a wheel rim of a vehicle, comprising:
A substantially gas impervious bag having an inflated condition and a deflated condition, normally stored in a deflated condition; a pressure sensor for the gas within the pneumatic tire adapted to generate a signal when the pressure within the pneumatic tire drops; a source of compressed gas; controlled by the sensor signal adapted to feed the compressed gas into the collapsed bag upon receipt of a signal from the sensor indicating sudden deflation of the pneumatic tire; whereby the bag will become inflated to assume a position which allows continued use of the vehicle without the support provided by the pneumatic tire.

2. The tire security system of claim 1, wherein the collapsed bag is supported on the tire rim within the inflated tire volume and when inflated, occupies the volume of the tire.

3. The tire security system of claim 1, wherein the collapsed bag is stored externally of the pneumatic tire volume and when expanded forms an auxiliary tire for the vehicle.

4. The tire security system of claim 2, including a plurality of bags supported at spaced intervals about the wheel rim.

5. The tire security system of claim 4, including separate compressed gas sources for inflating each of the bags.

6. The tire security system of claim 4, comprising a single gas container connectible to each of the plurality of airbags.

7. The tire security system of claim 4, including a single sensor for controlling the compressed gas source.

8. The tire security system of claim 1, including at least one air bag stored on the tire rim within the pneumatic tire volume and, at least a second airbag stored in a container affixed to the tire rim externally of said pneumatic tire volume.
